(19) United States
(12) Patent Application Publication
(10) Pub. No.: US 2001/0035093 A1
(43) Pub. Date: Nov. 1, 2001

(54) Gas permeable membrane apparatus

(76) Inventor: Takushi Yokota, Kurashiki-shi (JP)

Correspondence Address: Carol A. Lewis White, Esq., W. L. Gore & Associates, Inc., 551 Paper Mill Road, P.O. Box 9206, Newark, DE, 19714-9206, US

(21) Appl. No.: 09/801,169

(22) Filed: Mar. 2, 2001

(30) Foreign Application Priority Data
Mar. 3, 2000 (JP) 2000-59366

(51) Int. Cl. B01D 63/02

(52) U.S. Cl. 96/8

(57) ABSTRACT

A gas permeable membrane apparatus comprises a chamber having an inlet-end connector portion and an outlet-end connector portion; a tube bundle housed within said chamber and composed of a plurality of gas-permeable tubes; a cylindrical coupling insertable into each of the connector portions of said chamber, having at a first end thereof a line connector portion for connecting a liquid inlet line or outlet line and having at a second end thereof a tube bundle connector portion for connecting said tube bundle; a fastener member for threadably fastening each of said cylindrical couplings; and a ferrule arranged about the outer peripheral surface of each said cylindrical coupling interposed between said coupling and said connector when fastening said coupling with said fastener member so as to maintain a gas-tight seal of said cylindrical coupling.

### BACKGROUND OF THE INVENTION

1. Field of the Invention

The present invention relates to a gas permeable membrane apparatus that employs gas-permeable plastic tubes and is used for deaeration of gases present in solution in liquid passing through the tubes, or for aeration of liquid passing through the tubes by dissolving therein a gas such as ozone gas or CO₂ gas.

2. Description of Related Art

Deaeration units for removing dissolved gases from liquids, aeration units for dissolving gases such as ozone gas or CO₂ gas into liquids, and similar units typically have a bundle of gas-permeable plastic tubes housed within a chamber, the ends of the tubes being connected to a liquid inlet line and a liquid outlet line, respectively.

In deaeration units of this kind, a liquid for treatment flows into the plastic tubes, and the pressure within the chamber is lowered so that dissolved gases present in the liquid in the tubes are removed by the time that the liquid exits the tubes. In aeration units, a liquid for treatment flows into the plastic tubes, and the chamber is filled with a desired gas so that the gas becomes dissolved in the liquid in the tubes by the time that the liquid exits the tubes. Accordingly, it is important that the chamber be provided with a gas-tight seal, so that chamber pressure can be reduced efficiently in deaeration units, and so that leakage of feed gas from the chamber can be prevented in aeration units.

JP Y2 3-37681 (Prior Art citation 1) discloses a deaeration unit like that depicted in FIG. 18. The chamber 51 of the deaeration unit employs line connector portions 51a, 51b for connecting liquid inlet and outlet lines, each connector portion having a flange 51c, 51d formed thereon. The plastic tube bundle 52 housed within chamber 51 is produced by fusing the outer peripheral surfaces of the ends of the plastic tubes together with heat to effect gas-tight joining thereof and fuse them into a unitary structure, the fused portions having plastic sleeves 53 attached thereto. The two ends of the tube bundle 52 are inserted into the line connector portions 51a, 51b, and the flanges 54a, 55a of an inlet line 54 and an outlet line 55 are bolted to the flanges 51c, 51d of line connector portions 51a, 51b. When fastening the flanges together, O-rings 56, 57 are interposed at the end faces of the plastic sleeves 53 to provide a gas-tight seal in the line connector portions.

Disadvantages of joining together components by means of flanges include bulky and complicated design, as well as the need to remove bolts and nuts in order to disassemble the unit for installation or removal of piping, resulting in difficult maintenance. In gas permeable membrane units for applications that involve high purity liquids or corrosive gases (such as ozone gas), the chamber and piping (including the flanges) may be fabricated of corrosion-resistant material (e.g. a fluororesin), but this tends to drive up the overall cost of the unit.

A deaeration unit like that depicted in FIG. 19 has been proposed in JP-A 9-57009 (Prior Art citation 2) as a gas permeable membrane unit in which liquid- and gas-contacting members have shapes that are relatively easy to manufacture, allowing these to be fabricated from corrosion-resistant materials. The deaeration unit employs connector members 63 each having a tube bundle connector portion 63a at a first end thereof and a line connector portion 63b at a second end thereof for connection with lines 60 and with a tube bundle 62. Connector member 63 is inserted into a line attachment orifice 61a (or 61b) provided to the chamber 61, and with an O-ring 64 interposed between the rim of line attachment orifice 61a (or 61b) of chamber 61 and a flange formed on tube bundle connector portion 63a, the medial portion 63c of connector member 63 is secured in place by means of securing means 65. Through threadable engagement, securing means 65 forces the tube bundle connector portion 63a of connector member 63 tightly against the wall of chamber 61, with the interposed O-ring 64 providing a gas-tight seal between connector member 63 and the rim of line attachment orifice 61a (or 61b).

Elastic deformation of an O-ring held between two components acts to eliminate any gaps between the two components, so O-rings are widely used as sealing members for gas or liquid flow passages. With service for extended periods, however, they tend to lose elasticity so that sealing performance declines. Particularly in gas permeable membrane units in which the chamber is filled with a corrosive gas such as ozone, O-rings tend to deteriorate quickly, even when fabricated from corrosion resistant fluororubbers, making it necessary to frequently disassemble the unit to replace the O-rings. In applications involving dissolving ozone gas in liquids, even the use of O-rings of fluorine-based materials does not obviate the need to replace the O-rings on an annual basis in order to prevent gas leaks.

Replacing the O-rings requires that the upper wall of the chamber in which the line attachment orifices are situated have a detachable structure. Accordingly, the upper wall of the chamber cannot be joined to the housing portion of the chamber by inexpensive joining techniques such as welding. Rather, it is necessary to employ a joining technique in which the line attachment orifices are provided with flanges, and O-rings are inserted using bolts and nuts. This results in a more expensive apparatus.

These and other purposes of the present invention will become evident from review of the following specification.

### SUMMARY OF THE INVENTION

With the foregoing in view, it is an object of the present invention to provide a gas permeable membrane apparatus having a sealing mechanism that assures a good gas-tight seal of the chamber without using O-rings or flanges, and affords ease of replacement of lines and components.

The gas permeable membrane apparatus herein comprises: a chamber having an inlet-end connector portion and an outlet-end connector portion; a tube bundle housed within said chamber and composed of a plurality of gas-permeable tubes; a cylindrical coupling insertable into each of the connector portions of said chamber, having at a first end thereof a line connector portion for connecting a liquid inlet line or outlet line and having at a second end thereof a tube bundle connector portion for connecting said tube bundle; a fastener member for threadably fastening each of said cylindrical couplings; and a ferrule arranged about the outer peripheral surface of each said cylindrical coupling interposed between said coupling and said connector when fastening said coupling with said fastener member so as to maintain a gas-tight seal of said cylindrical coupling.

In preferred practice, said fastener member comprises a retainer portion for forcing said ferrule towards the inside of said chamber in the direction of the axis of said cylindrical coupling.

In preferred practice, the inner peripheral surface of said connector portion and the outer peripheral surface of said cylindrical coupling together define a groove of V-shaped cross section, and the outside peripheral surface of said ferrule is tapered so as to fit into said V-shaped groove.

In preferred practice, said ferrule comprises a detent portion provided to the tapered distal end thereof and said cylindrical coupling comprises a recess interlocking with said detent portion. Ideally, said detent portion is of hooked configuration.

In preferred practice, where the gas permeable membrane apparatus herein is to be employed as a deaeration apparatus, a vent orifice for reducing pressure within said chamber is provided to a wall of said chamber; said ferrule is provided with a detent portion (preferably a detent portion of hooked configuration) at the tapered distal end thereof, said cylindrical coupling is provided with a recess interlocking with said detent portion, and displacement of said cylindrical coupling due to a reduction in pressure is prevented by means of interlocking of the two elements.

In preferred practice, where the gas permeable membrane apparatus herein is to be employed in applications wherein a liquid flowing through the tubes is to be aerated with a gas, a gas supply orifice for supplying a gas to the interior of said chamber is provided to a wall of said chamber; the distal end of said ferrule in the direction of insertion thereof is provided with a detent portion; a recess for engaging said detent is provided to the outer peripheral surface of said cylindrical coupling; and displacement of said cylindrical coupling due to an increase in pressure is prevented by restricting displacement of said ferrule by means of the interlocked portions of said ferrule and said cylindrical coupling, and the retainer portion of said fastener member.

The gas permeable membrane apparatus set forth herein affords highly gas-tight sealing and far better seal durability than is achieved with O-rings. Continuous operation for extended periods is therefore possible. Since there is no need to periodically replace components, components such as the chamber can be joined using inexpensive techniques such as welding.

By fabricating all components that come into contact with liquids and gases from fluororesin and joining components by welding, it becomes possible to inexpensively provide a gas permeable membrane apparatus that may be used with chemical solutions such as strong acids, or strong alkalis, and corrosive process liquids and process gases such as ozone gas.

### DESCRIPTION OF THE DRAWINGS

The operation of the present invention should become apparent from the following description when considered in conjunction with the accompanying drawings, in which:

FIG. 1 is a sectional view showing the design of a first embodiment of the gas permeable membrane apparatus of the invention.

FIG. 2 is an enlarged view of the seal portion of the gas permeable membrane apparatus of the first embodiment.

FIG. 3 is a model diagram of a tube bundle arrangement.

FIG. 4 is a partly exploded view of fastener member components.

FIG. 5 is a diagram showing an alternative fastener member design.

FIG. 6 is an enlarged view of the ferrule used in the first embodiment.

FIG. 7 is a diagram showing alternative ferrule designs.

FIGS. 8(a) and 8(b) are diagrams showing an alternative ferrule design.

FIGS. 9(a), 9(b), and 9(c) are sectional views of a ferrule having detent portions of various hook configurations.

FIG. 10 is a diagram showing an alternative design for a ferrule having a detent portion.

FIG. 11 is an enlarged view of the seal portion of a gas permeable membrane apparatus employing the ferrule of FIG. 9.

FIGS. 12(a) and 12(b) are enlarged views of interlocking portions of the cylindrical coupling and ferrule with difering recess configurations.

FIG. 13 is an enlarged view of the seal portion of a gas permeable membrane apparatus employing the ferrule of FIG. 10.

FIG. 14 is an enlarged view of interlocking portions of the cylindrical coupling and ferrule of FIG. 13.

FIG. 15 is a diagram showing an alternative embodiment of the gas permeable membrane apparatus of the invention.

FIG. 16 is a block diagram of a deaeration system employing the gas permeable membrane apparatus of the Examples.

FIG. 17 is a block diagram of an ozone dissolving system employing the gas permeable membrane apparatus of the Examples.

FIG. 18 is a diagram showing the arrangement of a conventional deaeration apparatus.

FIG. 19 is a diagram showing the arrangement of a conventional deaeration apparatus.

### DETAILED DESCRIPTION OF THE INVENTION

The embodiments of the gas permeable membrane apparatus herein are described hereinbelow with reference to the accompanying drawings.

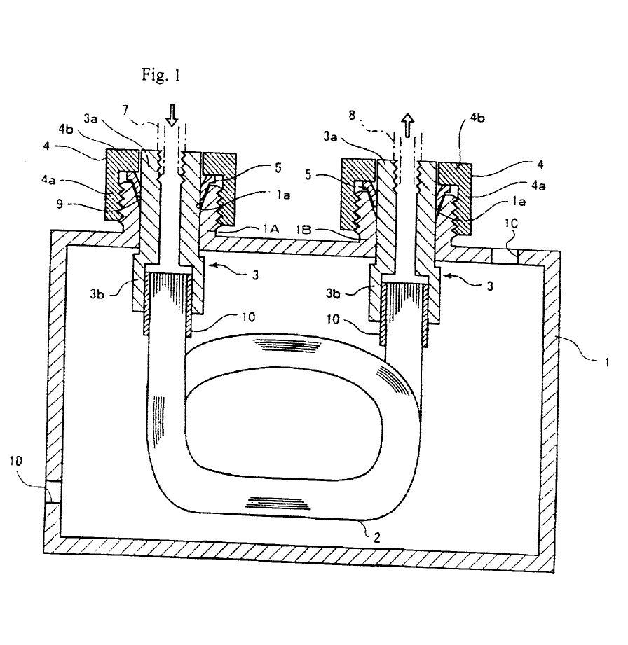

FIG. 1 is diagram depicting a first embodiment of the gas permeable membrane apparatus herein. The gas permeable membrane apparatus comprises a chamber 1 having an inlet-end connector portion 1A and an outlet-end connector portion 1B; a tube bundle 2 housed within the chamber 1 and composed of a plurality of gas-permeable tubes; cylindrical couplings 3, 3 insertable into the connector portions 1A, 1B of the chamber and serving as couplings for connection with line 7, 8 and with the tube bundle 2; fastener members 4, 4 for threadably fastening the cylindrical couplings 3, 3; and ferrules 5,5 arranged about the outer peripheral surfaces of the cylindrical couplings 4, 4 sic.

Each element is now described in order.

Chamber 1 is of cylindrical configuration, the upper wall thereof having an inlet-end connector portion 1A and an outlet-end connector portion 1B projecting therefrom, as well as being provided with gas passage orifices 1C, 1D. The tube bundle 2 is housed within the chamber 1; where the apparatus is to be used for deaeration, the area around the tube bundle 2 constitutes a space for pressure reduction, and where the apparatus is to be used for aeration, the area around the tube bundle 2 constitutes a space to be filled with a gas for aeration. Gas passage orifices 1C, 1D are openings for venting air from the chamber 1 or supplying a desired gas into the chamber 1; the number and location thereof in the gas permeable membrane herein are not particularly critical. It is sufficient for the chamber to consist of a sealed vessel; while the particular shape thereof may be selected arbitrarily, vessels of cylindrical configuration are preferable from a cost standpoint.

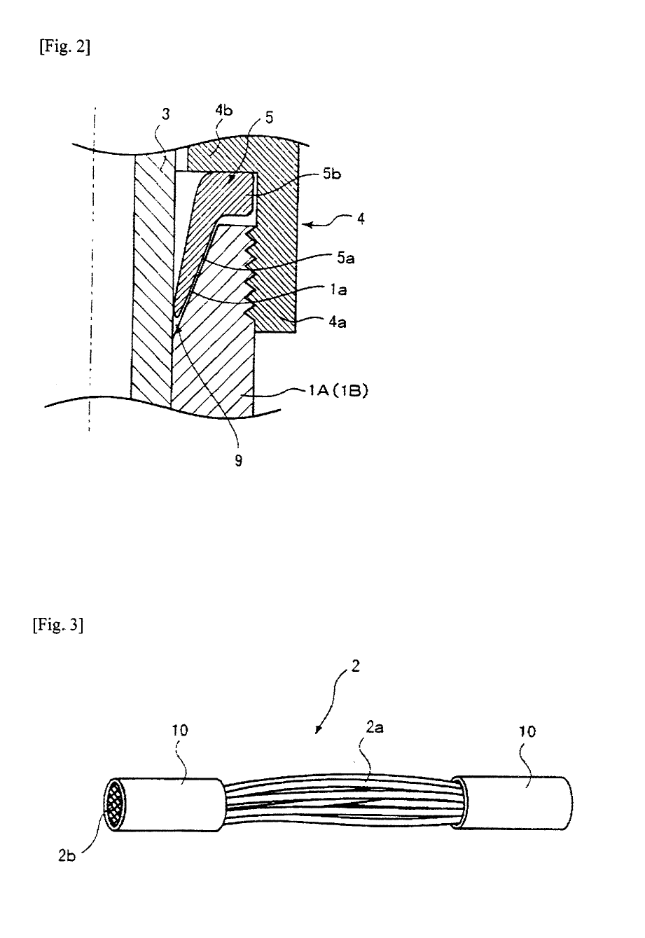

The outer peripheral surfaces of connector portion 1A, 1B are provided with threads for threadable attachment of fastener members 4, 4. As shown in FIG. 2, at the top end of each connector portion 1A, 1B is provided a taper 1a of increasing diameter going from the top end towards the outside of the chamber 1, so as to define a V-shaped groove 9 in cooperation with the outer peripheral surface of the cylindrical coupling 3 inserted into the connector portion 1A or 1B.

The material for the walls of chamber 1 may be any material capable of withstanding exposure to a particular gas (air in the case of a deaeration unit, and the gas filling the chamber 1 in the case of an aeration unit), examples being plastic materials such as polyethylene, polypropylene, polyvinyl chloride, polycarbonate, acrylic, or fluororesin; and metal materials such as stainless steel, steel, etc. For applications in which the chamber will be filled with a corrosive gas such as ozone, the use of fluororesins such as polytetrafluoroethylene (PTFE), tetrafluoroethylene/hexafluoropropylene copolymer (FEP), ethylene/tetrafluoroethylene copolymer (ETFE), tetrafluoroethylene/perfluoroalkyl vinyl ether copolymer (PFA), polychlorotrifluoroethylene (PCTFE), polyvinylidene fluoride (PVDF), or polyvinyl fluoride (PVF) are preferred.

As shown in FIG. 3, the tube bundle 2 comprises a plurality of gas-permeable tubes 2a, the tube bundle 2 being joined together in gas-tight fashion at its ends by means of thermally fusing the outer peripheral surfaces of the tubes 2a to produce a fused portion 2b of honeycomb configuration. Fused portion 2b is fitted into a sleeve 10, and the sleeve 10 is then unified therewith by means of thermal fusion using an adhesive with a lower melting point than the material of the tubes 2a (for example, an FEP adhesive in the case of PTFE tubes).

Each tube 2a is fabricated of gas-permeable material, examples thereof being polyethylene, polypropylene, and other polyolefins; polyurethane, polyamide, silicone, polyvinyl chloride, fluororesin, and other thermoplastic resins. The type of material may be selected appropriately with reference to the type of liquid flowed through the tube 2a and the type of gas contacting it, so as to resist corrosion thereby. For applications in which contamination of the liquid being treated must be avoided, applications in which chemical resistance is required, or applications employing highly corrosive gases such as ozone gas, fluororesins such as PTFE, FEP, ETFE, PFA, PCTFE, PVDF and PVF offer negligible elution and outstanding resistance to chemicals, heat, and ozone, and are preferred for this reason. Expanded porous PTFE in particular offers both the outstanding properties of PTFE and high gas permeability due to its porous structure, and is thus an ideal tube material for use in gas permeable membrane units for applications involving aeration of liquids with ozone gas.

Cylindrical couplings 3, 3 are respectively inserted into inlet-end connector portion 1A and outlet-end connector portion 1B of chamber 1. Cylindrical coupling 3 has at a first end thereof a line connector portion 3a for connection to liquid inlet line 7 (or to liquid outlet line 8), and at a second end thereof a tube connector portion 3b for connection to tube bundle 2.

The sleeve 10 sheathing the end of the tube bundle 2 is inserted into tube connector portion 3b and joined in liquid-tight fashion to cylindrical coupling 3 by means of welding, fusion, screw coupling, or the like. Line connector portion 3a may be provided with any design affording connection to line 7 (or 8); if desired, a thread may be provided to enable threadable attachment of the line.

As cylindrical coupling 3 will come into contact with liquid flowing through tubes 2a, it must be fabricated of material able to withstand the liquid be used. Specific examples are plastic materials such as polyethylene, polypropylene, polyvinyl chloride, polycarbonate, acrylic, or fluororesin; and metal materials such as stainless steel, steel, etc., selected appropriately with reference to the type and degree of purity of the liquid used. In aeration units, cylindrical coupling 3 will come into contact with gas filling the chamber 1, and accordingly should be fabricated of material resistant to the gas in question. In applications in which the liquid will be aerated with ozone, for example, fluororesins such as PTFE, FEP, ETFE, PFA, PCTFE, PVDF and PVF offer negligible elution and outstanding resistance to chemicals, heat, and ozone, and are preferred for this reason as materials for the cylindrical couplings 3.

Fastener members 4, 4 are threadably attached to the inlet-end connector portion 1B and outlet-end connector portion 1c.

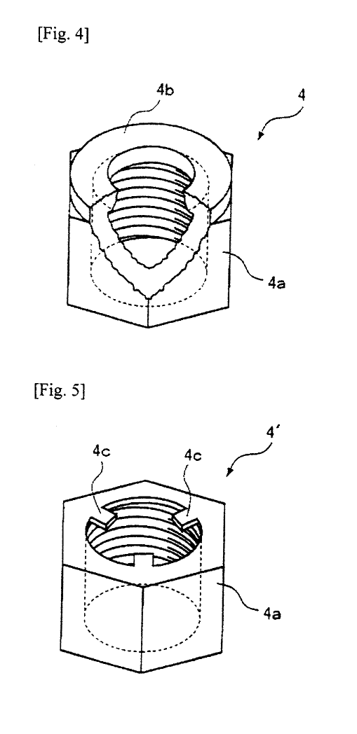

As shown in FIG. 4, each fastener member 4 comprises a nut portion 4a threadably attachable to inlet-end connector portion 1A or outlet-end connector portion 1B, and an annular top plate 4b integrally formed with the upper face of nut portion 4a. The inside diameter of annular top plate 4b is smaller than the inside diameter of nut portion 4a and larger than the outside diameter of cylindrical coupling 3. In this way the annular top plate 4b comes into abutment with the basal end 5b of ferrule 5 in the insertion direction thereof, and functions as a retainer portion for forcing the ferrule towards the inside of chamber 1 in the direction of the axis of cylindrical coupling 3.

As a general rule, fastener member 4 does not come into contact with either liquid flowing through tubes 2a or gases supplied to the chamber 1, and thus the only requirement as regards the material thereof is that the material be able to ensure tight threadable attachment to the connector portion 1A (or 1B) to which it is attached. Material selection will depend to a certain extent on the material of the chamber 1, but a broad range of materials can be used, like plastic materials such as polyethylene, polypropylene, polyvinyl chloride, polycarbonate, acrylic, or fluororesin; and metal materials such as stainless steel, steel, etc.

The fastener member 4 may have a nut portion 4a threadably attachable to connector portion 1A (or 1B), or, alternatively, may be a fastener member 4′ wherein the top end of nut portion 4a has a plurality of protruding portions 4c that can function as retainer portions projecting from the inside rim thereof, as depicted in FIG. 5.

Ferrules 5, 5 insert into V-shaped grooves 9 defined by the outer peripheral surfaces of cylindrical couplings 3, 3 and the inner peripheral tapers at the top ends of connector portions 1A, 1B.

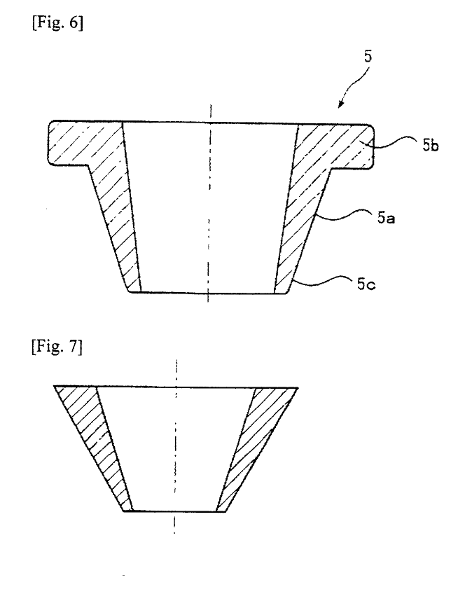

As shown in FIG. 6, the outer peripheral surface of ferrule 5 has a tapered portion 5a allowing it to mate with the tapered portion 1a of the connector portion 1A or 1B, which defines a V-shaped groove 9. The ferrule becomes thinner towards the distal end of the taper, giving it a wedge-shaped cross section. An annular flange is formed at the basal end 5b (i.e., the basal end in the insertion direction) of the taper of the ferrule 5 so that it comes into abutment with the top plate 4b of fastener member 4.

Ferrule 5 is arranged about the outer peripheral surface of cylindrical coupling 3 with the taper distal end portion 5c thereof facing the chamber, so that when the fastener member 4 is threadably attached to connector portion 1A (or 1B), the wedge-shaped distal end portion 5c of ferrule 5 inserts into the distal end portion of V-shaped groove 9, mating with the tapered portion 1a of the connector portion 1A (or 1B). At this point the top plate 4b of fastener member 4 comes into abutment with the basal end 5b of ferrule 5, functioning as a retainer portion for forcing the ferrule towards the inside of the chamber in the direction of the axis of cylindrical coupling, so that the inserted ferrule 5 is held in place.

By inserting ferrule 5 between the cylindrical coupling 3 and the connector portion 1A (or 1B) of chamber 1 and threadably attaching fastener member 4 in this way, the gap between cylindrical coupling 3 and connector portion 1A (or 1B) is fastened shut to provide gas-tight sealing of chamber 1.

In contrast to seal designs in which an O-ring held between two components between which it is held undergoes elastic deformation to eliminate the gap between these components, ferrule 5 provides sealing by eliminating the gap between two components (namely, cylindrical coupling 3 and connector portion 1A (or 1B)) by means of insertion into the gap between these two components between which it is held. Since the inserted ferrule 5 is held in place by pressing force provided by a retainer portion, in preferred practice the ferrule 5 will receive transmitted pressing force. Accordingly, the material of the ferrule 5 will preferably be a material that resists elastic deformation, and that moreover can withstand gases, since the member comes into contact with gas present in chamber 1. Specific examples are plastic materials such as polyethylene, polypropylene, polyvinyl chloride, polycarbonate, acrylic, or fluororesin; and metal materials such as stainless steel, steel, etc., selected appropriately with reference to the type of gas with which it will come into contact. In applications in which the liquid will be aerated with ozone, for example, fluororesins such as PTFE, FEP, ETFE, PFA, PCTFE, PVDF and PVF are preferred due to their outstanding resistance to ozone.

A gas permeable membrane apparatus of the preceding design is used in the following manner.

A liquid passage line 7 (or 8) is attached to the line connector portion 3a of each cylindrical coupling 3, and liquid is delivered through the line 7 connected to the inlet end, whereupon the liquid flows through the tubes 2a. Where the apparatus is to be used as a deaeration unit, a vacuum pump is connected to the gas passage orifice 1C provided to a side wall of the chamber 1 so that a partial vacuum may be created within chamber 1. Gas passage orifice 1D is normally closed, and is used as a drain hole in the event that liquid should leak from the tubes or tube bundle connections. The reduced pressure in chamber 1 causes dissolved gases present in the liquid passing through gas-permeable tubes 2a to be removed via the walls of tubes 2a. Where the apparatus is to be used as an aeration unit, a gas supply unit is connected to gas passage orifice 1C or 1D provided to a side wall of the chamber 1, and a gas is supplied to the chamber 1 from the gas supply unit so that the tubes 2a are exposed to an atmosphere of the gas. The gas enters the gas-permeable tubes 2a through the walls of tubes 2a and dissolves in the liquid flowing through the tubes 2a. The other gas passage orifice is used as a vent orifice for venting air from the chamber 1.

Regardless of whether the apparatus is used as an aeration unit or deaeration unit, the chamber is sealed in gas-tight fashion by means of the ferrule 5 being forced between the cylindrical coupling 3 and the connector portion 1A (or 1B) through tightening of the fastener member 4. Since, unlike an O-ring, the ferrule 5 does not experience deterioration due to tightening, there is substantially no resultant drop in the sealing performance thereof, providing a seal of exceptional durability. Further tightening of the fastener member 4 simply forces the ferrule 5 further down into the distal end portion of the V-shaped groove 9 between cylindrical coupling 3 and connector portion 1A (or 1B), so that the ferrule 5 does not rupture and maintains its sealing performance. The seal portion herein provides service for extended periods without the need to replace components, allowing the upper wall and housing portion of the chamber to be joined by a simple method such as welding.

Where the gas permeable membrane apparatus herein is used as an aeration unit, the interior of the chamber 1 becomes pressurized by the gas fed into it, causing force to act on the ferrule 5 sealing element in a direction pushing it outward (i.e., towards the basal end in the direction of insertion) from the chamber. In the embodiment depicted in FIG. 1, which employs a fastener member having a retainer portion, the flange at the basal end 5b of ferrule 5 in the insertion direction thereof comes into abutment with the top plate 4b of fastener member 4, preventing displacement of the ferrule 5 in the outward direction, and as a result preventing displacement of the cylindrical coupling 3 so that a gas-tight seal is maintained.

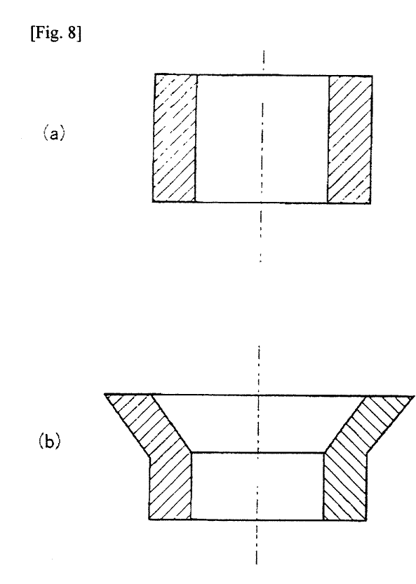

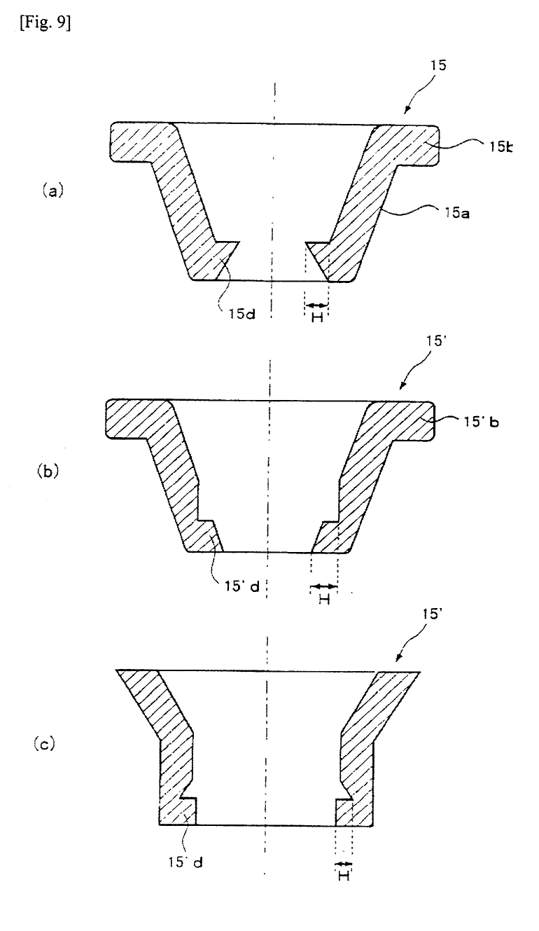

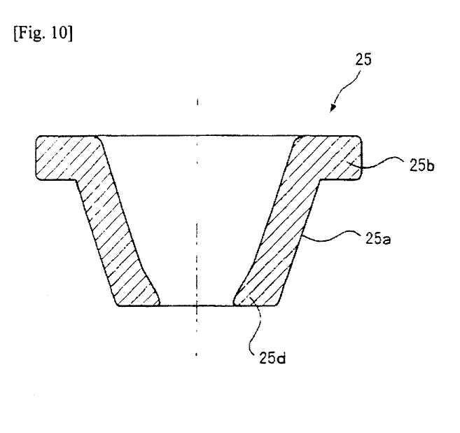

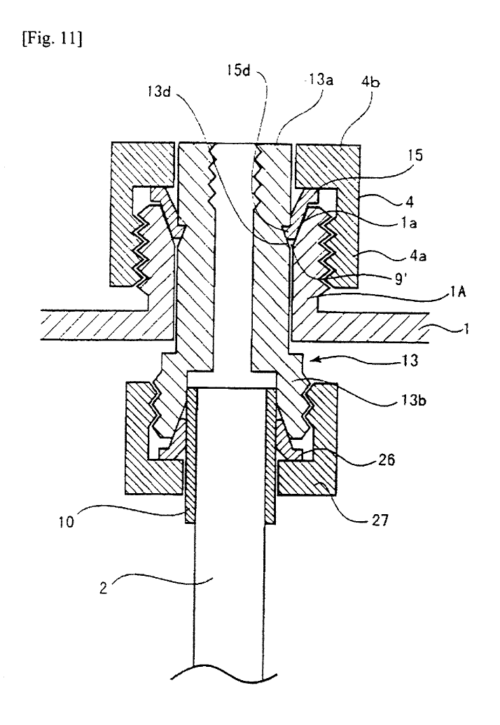

The ferrule employed in the gas permeable membrane apparatus herein is not limited to the design depicted in FIG. 6. Where the basal end in the insertion direction is constructed of thick-walled material, as shown in FIG. 7, no flange is necessary. Nor is it necessary that the distal end portion be of wedge configuration, or that the taper be coextensive with the entire outer peripheral surface: alternative configurations include the annular element depicted in FIG. 8(a) and the element depicted in FIG. 8(b), which has a tapered portion extending only over the top portion (i.e., the basal end in the insertion direction) of the outer peripheral surface. Alternatively, a detent portion 15d or 15′d of hook configuration may be provided in the basal end of the ferrule in the insertion direction thereof, as shown in FIG. 9, or the taper distal end portion may have a thick-walled flattened configuration like that depicted in FIG. 10 so that the inside bottom edge acts as a detent portion 25d.

FIG. 11 is a diagram depicting an inlet-end connector portion of a gas permeable membrane apparatus, employing a ferrule 15 with a detent portion 15d of hook configuration. Gas permeable membrane units having this sealing structure are particularly suitable for deaeration applications.

A cylindrical coupling 13 is inserted into inlet-end connector portion 1A of chamber 1, and a fastener member 4 is threadably attached about the outside peripheral face of inlet-end connector portion 1A. At the top end of connector portion 1A is formed a tapered portion 1a defining a V-shaped groove 9′ in cooperation with the outer peripheral surface of cylindrical coupling 13 in a manner analogous to that depicted in FIG. 1. Ferrule 15 is inserted into the V-shaped groove 9′ defined by cylindrical coupling 13 and connector portion 1A, ferrule 15 having formed on the outer peripheral surface thereof a taper 15a that mates with the tapered portion 1a of connector portion 1A. A detent portion 15d of hook configuration is formed at the distal end of the taper of ferrule 15. A recess 13d for engaging the hook-shaped detent portion 15d of ferrule 15 is formed in the outer peripheral surface of cylindrical coupling 13.

The hook-shaped detent portion 15d of ferrule 15 is not limited as to configuration or projection height H, but in preferred practice projection height H will be about 0.1 to about 5 mm, and preferably about 0.5 to about 3 mm.

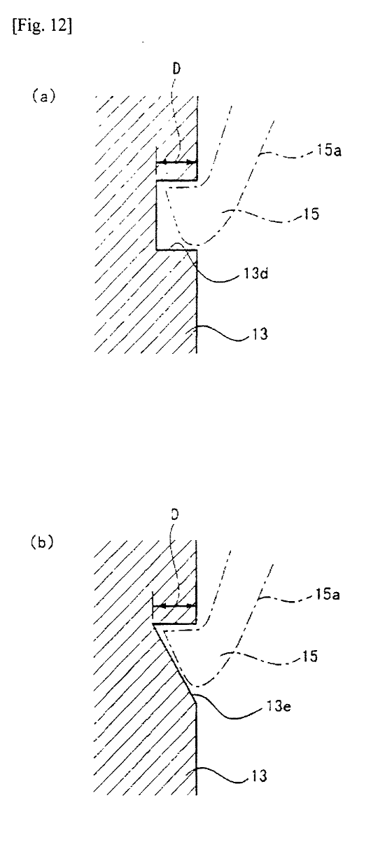

Ideally, the shape of the recess 13d in cylindrical coupling 13 will be one that interlocks with the detent portion 15d of ferrule 15, but any configuration affording engagement with detent portion 15d may be used. For example, the recess 13d of square cross section shown in FIG. 12(a) may be used, as may the recess 13e depicted in FIG. 12(b), which has a taper that narrows towards the basal end of the ferrule in the insertion direction thereof. With either design, the sealing function is enhanced through interlocking of the cylindrical coupling 13 and the ferrule 15, and displacement of cylindrical coupling 13 towards the chamber 1 interior due to pressure reduction within the chamber 1 is prevented, providing a good durable seal in deaeration applications.

The depth D of the recess may be selected appropriately with reference to the apparatus, thickness of the cylindrical coupling 13, etc., but in terms of preventing displacement of cylindrical coupling 13, a depth of about 0.1 to about 7 mm is preferred, with about 0.5 to about 5 mm being more preferred. Recess 13d may consist of a groove extending around the entire circumference of cylindrical coupling 13, or where the detent portion 15d is situated at a particular suitable location of the ferrule, it may be situated at a suitable location on the outer peripheral surface of cylindrical coupling 13 corresponding to that of the detent portion 15d.

In the arrangement depicted in FIG. 1, connection of the tube bundle with the cylindrical couplings is accomplished through liquid-tight bonding by means of welding or fusion, but in the embodiment depicted in FIG. 11, a second ferrule 26 (termed a “tube bundle ferrule” to distinguish it from the ferrule interposed between the cylindrical coupling and the connector portion) is interposed between the outside wall of the sleeve 10 and the cylindrical coupling 13, and the outside of tube bundle connector 13b is fastened by means of a second fastener member 27 (termed a “tube bundle fastener member” to distinguish it from the fastener member used for the line connector portions) to produce a liquid-tight seal.

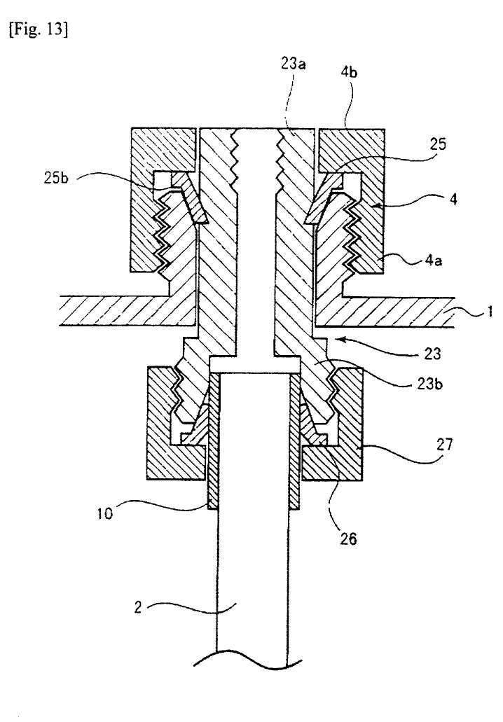

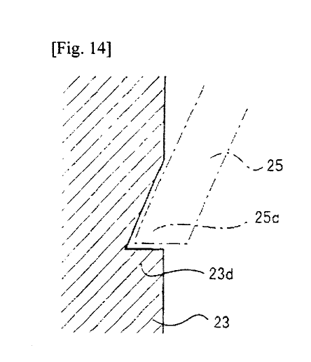

FIG. 13 shows a connector portion in a gas permeable membrane apparatus employing the ferrule 25 depicted in FIG. 10. Interlocking of the detent portion 25d at bottom edge of ferrule 25 and the cylindrical coupling 23 is depicted in FIG. 14. In FIG. 13, identical symbols indicate elements similar to those in FIG. 11 and requiring no additional description. As described hereinbelow, this sealing structure is suitable for applications in which the chamber is pressurized.

In order to facilitate insertion of detent portion 25d towards the chamber interior, the outer peripheral surface of cylindrical coupling 23 is provided with a recess 23d having a taper that narrows in the direction of ferrule insertion. Accordingly, interlocking of the recess 23d of cylindrical coupling 23 with the detent portion 25d of the ferrule restricts displacement of cylindrical coupling 23 towards the basal end in the direction of ferrule insertion (i.e., outward from the chamber), and therefore prevents loosening of the seal due to pressurization of chamber 1. Particularly when a fastener member 4 having a top plate 4b is used, the basal end 25b of ferrule 25 comes into abutment with the top plate 4b so that the ferrule 25 is forced in the direction of ferrule insertion. In other words, the top plate 4b functions as a stopper for ferrule 25, restricting displacement of ferrule 25 per se towards the basal end in the direction of ferrule insertion (i.e., outward from the chamber). Since displacement of the ferrule 25 is restricted, displacement of cylindrical coupling 23 is restricted as well, so that a good seal is maintained even when the chamber 1 is pressurized.

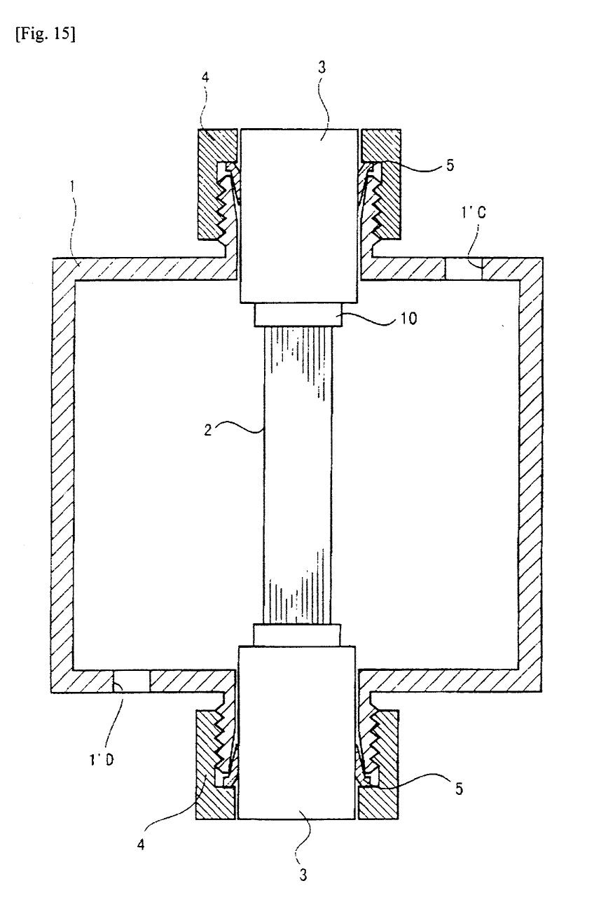

The gas permeable membrane apparatus herein is not limited to the arrangement for housing the tube bundle 2 shown in FIG. 1. In the gas permeable membrane apparatus of an alternative arrangement depicted in FIG. 15, the tube bundle 2 is housed in an I-shaped arrangement within a chamber 1′ provided with an inlet-end connector portion and an outlet-end connector portion situated on opposing chamber walls. For applications involving aeration with a heavy gas such as ozone, to ensure uniform contact of the gas with the tubes it is preferable to use an arrangement like that depicted in FIG. 15, in which the gas is supplied from an gas passage orifice 1′D situated in the bottom wall, and the gas is vented from a gas passage orifice 1′C situated in the top wall.

The gas permeable membrane apparatus herein is not limited to the arrangements described above wherein a liquid is flowed through the tubes, with the chamber space outside of the tubes containing a gas phase. Alternative arrangements in which a liquid is flowed through the chamber, and the tubes contain a gas flow or a vacuum, are also possible.

### EXAMPLES

The gas-tight sealing obtained using the gas permeable membrane apparatus herein for deaeration and for aeration with an ozone feed gas is described in greater detail hereinbelow.

Degassing Unit

The gas permeable membrane apparatus used a tube bundle composed of 19 PTFE tubes (inside diameter 1.0 mm, outside diameter 1.8 mm, length 5 m) was installed within a cylindrical polypropylene chamber 140 mm in outside diameter and 300 mm in length, and had the sealing structure depicted in FIG. 11. The cylindrical couplings and ferrules consisted of PTFE, and the fastener members consisted of polypropylene.

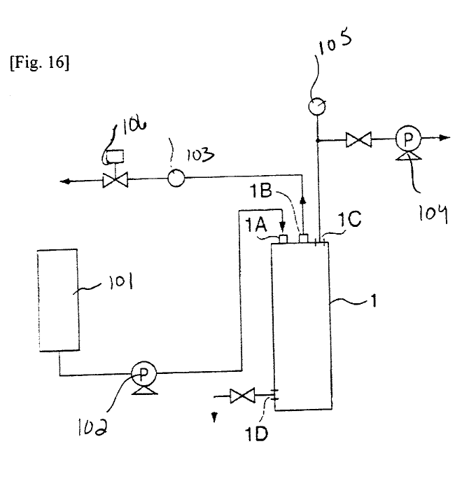

This gas permeable membrane apparatus was connected to a degassing system like that depicted in FIG. 16. Specifically, the line hooked up to the cylindrical coupling inserted into the inlet-end connector 1A carried liquid for deaeration delivered from a tank 101 by means of a pump 102. The line hooked up to the cylindrical coupling inserted into the outlet-end connector 1B was provided with an in-line dissolved oxygen meter 103 (UC-12 ex Central Kagaku) to enable measurement of dissolved oxygen concentration in the liquid. A vacuum pump was connected to a gas passage orifice 1C provided to the chamber so that a partial vacuum could be created in the chamber 1 by operating the vacuum pump 104. The degree of vacuum in the chamber 1 was measured with a vacuum pressure gauge 105. In the piping system, by closing an electromagnetic valve 106 installed on the liquid outlet line, water pressure could be applied in the line extending from the water feed pump 102 to the electromagnetic valve 106.

In the piping system, with the liquid outlet line of the gas permeable membrane apparatus shut off, water was supplied from the tank to the tube bundle to bring the water pressure to 0.2 MPa (gauge pressure). The system was left in the pressurized state for 10 minutes to verify that there was no leakage from the water outlet orifice of the chamber 1, and the line extending from the water feed pipe to the tube bundle was checked for water-tight sealing. Next, the vacuum pump was operated to evacuate the chamber, and after verifying that pressure was 13 kPa, the valve situated between the vacuum pressure gauge and the vacuum pump was closed, leaving the system in this state for 10 minutes. During this time no change in the vacuum pressure gauge reading was observed, and it was confirmed that there was a gas-tight seal at the gas passage orifice to which the vacuum pump was connected.

(1) Deaeration Efficiency as Determined by Measurement of Dissolved Oxygen

Tap water (25° C., dissolved oxygen concentration 8.1 ppm) was supplied to the chamber at a rate of 50 cc/min and deaerated therein under a 7 kPa vacuum. The discharged water had a dissolved oxygen concentration of 4.6 ppm, demonstrating good deaeration capability.

Next, tap water containing 1 mass % of a surfactant was introduced in place of ordinary tap water The discharged water had a dissolved oxygen concentration of 4.8 ppm.

Next, room temperature ultra-pure water (resistivity 17.3 MΩ·cm) was supplied to the chamber at a rate of 200 cc/min and deaerated therein under a 13 kPa vacuum. The resistivity of the purified water outflow was 17.1 MΩ·cm, demonstrating that the resistivity of the purified water was substantially unaffected, that is, there was no elution of metal ions and other contaminants from the deaeration unit. Measurements of ultra-pure water resistivity were made with an HEC-110 ex Denki Kagaku Keiki.

Next, 98% ethyl alcohol (dissolved oxygen concentration 8.1 ppm prior to deaeration) at 25° C. was supplied to the chamber at a rate of 50 cc/min and deaerated therein under a 7 kPa vacuum. The discharged ethanol had a satisfactory dissolved oxygen concentration of 6.1 ppm.

In all of the tests, deaeration capability was good and the gas permeable membrane apparatus had a gas-tight seal.

(2) Seal Durability

The chamber was brought to a 13 kPa vacuum, and while cycling the electromagnetic valve open for 1 second and closed for 2 seconds, tap water (at room temperature) containing 1.0 mass % of a surfactant was flowed therethrough for 3,000,000 cycles. Liquid pressure fluctuated between 0 and 0.4 MPa (gauge pressure) with opening and closing of the electromagnetic valve.

No change in the degree of vacuum within the chamber was observed during operation for 3,000,000 cycles, and the dissolved oxygen concentration of the outflowing tap water showed negligible fluctuation. In this way, gas-tight sealing and good deaeration capability with extended operation were demonstrated.

Ozone Dissolving Unit

A gas permeable membrane apparatus housing a tube bundle composed of 61 porous PTFE tubes (inside diameter 2.0 mm, outside diameter 3.0 mm, length 1.35 m) within a PVDF chamber 1 140 mm in outside diameter and 300 mm in length, and having the sealing structure depicted in FIG. 13 was employed as an ozone dissolving unit. The unit employed PTFE cylindrical couplings, PTFE ferrules, and PVDF fastener members.

With the liquid outlet line of the gas permeable membrane apparatus shut off, deionized water was supplied from the tank to the tube bundle to bring the water pressure to 0.2 MPa (gauge pressure). The system was left in the pressurized state for 10 minutes to verify that there was no water leakage from the gas passage orifice situated in the bottom of chamber 1, and the line extending from the water feed pipe to the tube bundle was checked for watertight sealing. Next, air was pumped in through the gas passage orifice until air pressure reached 0.2 MPa (gauge pressure). The gas passage orifice was then shut, and the pressurized chamber 1 was submerged in water. No air leakage from chamber 1 was observed, demonstrating that the chamber 1 was sealed in gas-tight fashion.

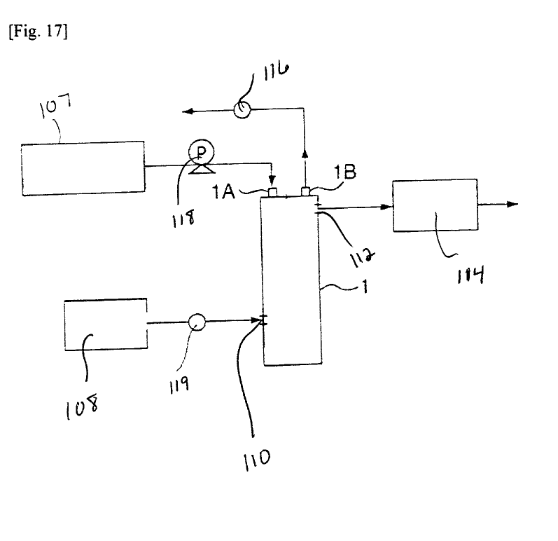

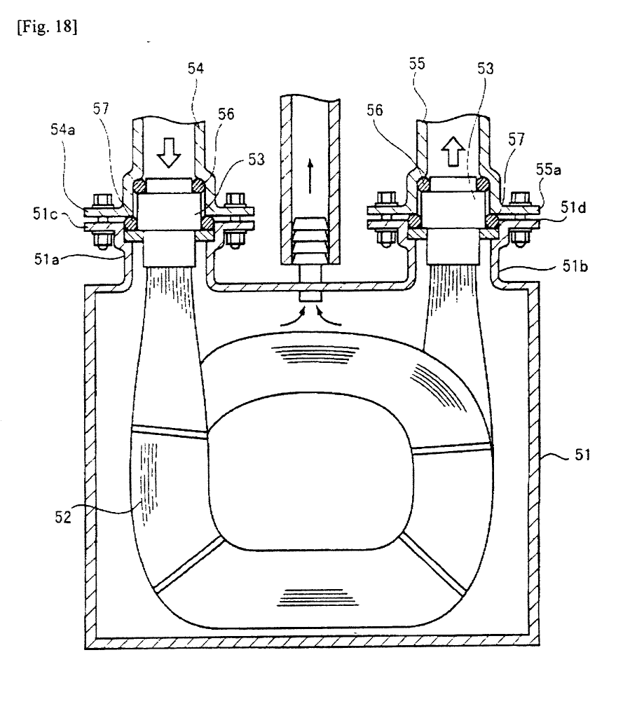

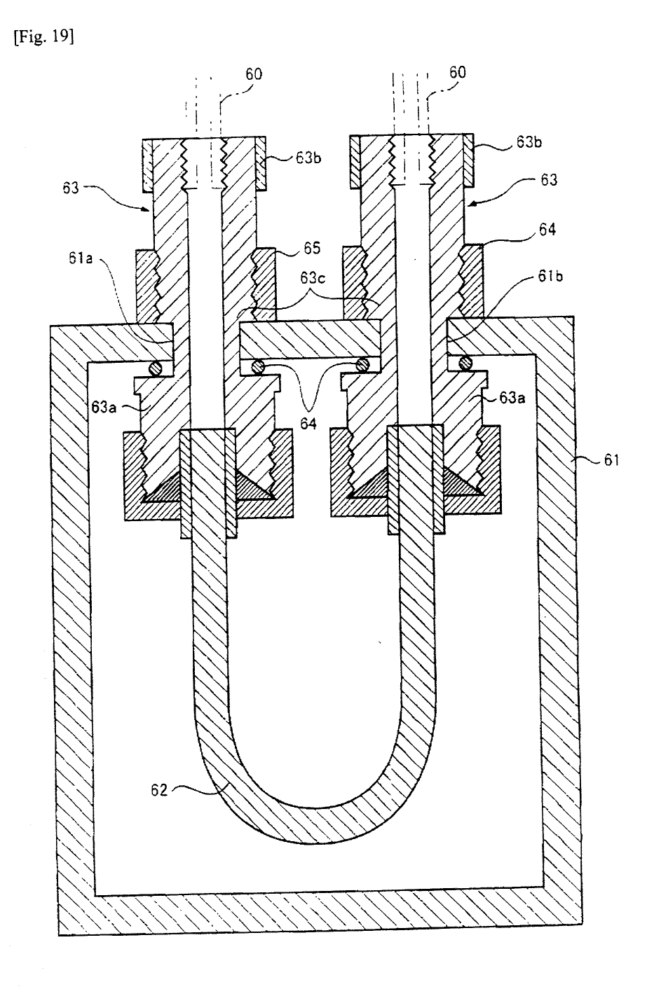

The gas permeable membrane apparatus was hooked up to the system depicted in FIG. 17. Ozone gas generated by an ozone gas generator 108 was supplied to chamber 1 through a gas meter 119 and via a gas passage orifice 110 situated at the bottom of the chamber 1 while venting the air present in the chamber 1 via a gas passage orifice 112 situated at the top of the chamber to fill the chamber 1 with ozone. The discharged ozone was decomposed by a an ozone gas decomposing unit 114 to render it harmless. Deionized water was pumped (pump 118) from a tank 107 through a line connected to the cylindrical coupling inserted in inlet-end connector portion 1A and supplied to the tube bundle. An in-line ozone water concentration meter 116 was installed on the line connected to the cylindrical coupling inserted in outlet-end connector portion 1B to enable measurement of ozone concentration in the water exiting the ozone dissolving unit.

(1) Aeration with Ozone

Using this system, deionized water (at 25° C.) was supplied to the gas permeable membrane apparatus at a flow rate of 5 L/min and flowed through the tubes at a water pressure of 200 kPa (gauge pressure). Ozone gas was supplied from the ozone generator to the chamber under the conditions: ozone concentration 200 g/m³ (normal); ozone gas pressure 150 kPa (gauge pressure); ozone gas flow rate 3 L/min. The ozone concentration of the water exiting the ozone dissolving unit was 18 ppm, demonstrating that as the water flowed through the tubes, the ozone gas present in the chamber permeated through the tube walls and dissolved in the water. Ozone concentration from the ozone generator was measured with a gFFOZ+minSCI ex IN USA. Dissolved ozone concentration in the water was measured with a dFFOZ+minSCI ex IN USA.

(2) Seal Durability

The ozone dissolving unit was operated under the above conditions for a two-year period. An ozone gas concentration meter was installed in the chamber of the ozone dissolving unit to monitor for ozone gas leaks, but no ozone gas leaks were detected over the two-year period, demonstrating that the gas-tight seal provided by the sealing structure in the unit remained unimpaired.

Without intending to limit the scope of the present invention, the following examples illustrate how the present invention may be made and used:

While particular embodiments of the present invention have been illustrated and described herein, the present invention should not be limited to such illustrations and descriptions. It should be apparent that changes and modifications may be incorporated and embodied as part of the present invention within the scope of the following claims.

The invention claimed is:

1. A gas permeable membrane apparatus comprising:
a chamber having an inlet-end connector portion and an outlet-end connector portion;
a tube bundle housed within said chamber and composed of a plurality of gas-permeable tubes;
a cylindrical coupling insertable into each of the connector portions of said chamber, having at a first end thereof a line connector portion for connecting a liquid inlet line or outlet line and having at a second end thereof a tube bundle connector portion for connecting said tube bundle;
a fastener member for threadably fastening each of said cylindrical couplings; and
a ferrule arranged about the outer peripheral surface of each said cylindrical coupling interposed between said coupling and said connector when fastening said coupling with said fastener member so as to maintain a gas-tight seal of said cylindrical coupling.

2. The gas permeable membrane according to claim 1 wherein said fastener member comprises a retainer portion for forcing said ferrule towards the inside of said chamber in the direction of the axis of said cylindrical coupling.

3. The gas permeable membrane according to claim 1 or 2 wherein the inner peripheral surface of said connector portion and the outer peripheral surface of said cylindrical coupling together define a groove of V-shaped cross section.

4. The gas permeable membrane according to claim 3 wherein the outside peripheral surface of said ferrule is tapered so as to fit into said V-shaped groove.

5. The gas permeable membrane according to any of claims 1 to 4 wherein said ferrule comprises a detent portion provided to the tapered distal end thereof, and said cylindrical coupling comprises a recess interlocking with said detent portion.

6. The gas permeable membrane according to claim 5 wherein said detent portion is of hooked configuration.

7. The gas permeable membrane according to claim 5 or 6 wherein a vent orifice for reducing pressure within said chamber is provided to a wall of said chamber; and
displacement of said cylindrical coupling due to a reduction in pressure is prevented by means of interlocking of the catch portion of said ferrule with the recess of said cylindrical coupling.

8. The gas permeable membrane according to claim 2 wherein a gas air supply orifice for supplying a gas to the interior of said chamber is provided to a wall of said chamber;
the distal end of said ferrule in the direction of insertion thereof is provided with a detent portion;
a recess for engaging said detent is provided to the outer peripheral surface of said cylindrical coupling; and
displacement of said cylindrical coupling due to an increase in pressure is prevented by restricting displacement of said ferrule by means of the interlocked portions of said ferrule and said cylindrical coupling, and the retainer portion of said fastener member.
